(19) United States
(12) Patent Application Publication
(10) Pub. No.: US 2024/0221037 A1
(43) Pub. Date: Jul. 4, 2024

(54) COMPUTERIZED-METHOD AND COMPUTERIZED-SYSTEM FOR GENERATING A COACHING SESSION HAVING COACHING CONTENT RELATED TO CUSTOMER EXPERIENCE, IN A WEB APPLICATION FOR MANAGING COACHING SESSIONS

(71) Applicant: NICE LTD., Ra'anana (IL)

(72) Inventors: Amol ANWADE, Pune (IN); Mahesh Bairagi, Pune (IN); Somnath Bhambure, Pune (IN); Vinayak Kaviskar, Pune (IN); Vishakha Bhope, Pune (IN)

(21) Appl. No.: 18/092,345

(22) Filed: Jan. 2, 2023

(51) Int. Cl. G06Q 30/02; G06F 18/2413; G06Q 30/0282

(52) U.S. Cl. CPC G06Q 30/0281; G06F 18/24147; G06Q 30/0282

(57) ABSTRACT

A computerized-method for generating a coaching session having coaching content related to customer experience, in a web application for managing coaching sessions is provided herein. The computerized-method includes, based on received user selection of coaching content having first one or more groups, via a graphical User Interface (GUI), for an agent, operating a Customer Feedback Relevancy Score (CFRS) module, the CFRS module includes: (i) calculating a CFRS and presenting the calculated CFRS via the GUI. The CFRS indicates relevancy of user selection of coaching content having the first one or more groups to customer experience (CX); and (ii) determining second one or more groups of coaching content to maximize the CFRS and presenting the second one or more groups via the GUI and an increase in calculated CFRS to reach a maximum CFRS to improve CX.

### TECHNICAL FIELD

The present disclosure relates to the field of data analysis and more specifically, to generating a coaching session having coaching content related to customer experience, in a web application for managing coaching sessions, in a contact center.

### BACKGROUND

Coaching for agents in contact centers, as conducted today, primarily focuses on agent performance metrics values and its manual association with coaching contents, e.g., focus areas and behavior. The coaching content selection is often driven by skills, visibility and judgement of a coach. Currently, the process of coaching content selection is centered around improving the agent performance which is not a direct customer experience (CX) improvement, rather than improving the CX directly by focusing on needs and feedback from the customers. This indirect approach leaves a gap to empathize with feedback of the customer, which practically will be interacting with the contact center. Therefore, there is a need for a technical solution that will bring an approach to create a customer centric coaching session with data backed contents which are relevant to customer feedback and needs.

Accordingly, there is a need for a system and method for generating a coaching session having coaching content related to customer experience, in a web application for managing coaching sessions.

### SUMMARY

There is thus provided, in accordance with some embodiments of the present disclosure, a computerized-method for generating a coaching session having coaching content related to customer experience, in a web application for managing coaching sessions.

In accordance with some embodiments of the present disclosure, in a system that is running the web application for managing coaching sessions, the web application for managing coaching sessions accepts coaching content having one or more interrelated groups to create a coaching session, based on received user selection of coaching content having first one or more groups, via a graphical User Interface (GUI), for an agent, and may operate a Customer Feedback Relevancy Score (CFRS) module.

Furthermore, in accordance with some embodiments of the present disclosure, the CFRS module may include: (i) calculating a CFRS and presenting the calculated CFRS via the GUI. The value of the CFRS indicates relevancy of user selection of coaching content having the first one or more groups to customer experience (CX); and (ii) determining second one or more groups of coaching content to maximize the CFRS and presenting the second one or more groups via the GUI and an increase in calculated CFRS to reach a maximum CFRS to improve CX.

Furthermore, in accordance with some embodiments of the present disclosure, the CFRS module may further include: (i) retrieving customer-feedback related data during a preconfigured period for the agent from a feedback-management component; (ii) extracting parameters from the customer-feedback related data for each feedback. The parameters may include at least one of: feedback comment, associated Net promoter score (NPS), assigned categories, customer and agent details and associated interaction identifier; (iii) retrieving mapping between categories and the first one or more groups; (iv) operating an algorithm to calculate a CFRS for each category based on the extracted parameters based on the retrieved mapping; (v) counting occurrences of each category to determine a median number for each category; (vi) detecting a preconfigured number of categories having highest variance to yield impacted categories; (vii) sorting interactions associated with the impacted categories based on NPS score; and (viii) extracting a preconfigured number of associated interactions which have an NPS score below a preconfigured threshold and having lowest NPS score to be added to the generated coaching session.

Furthermore, in accordance with some embodiments of the present disclosure, before calculating the CFRS, normalizing the customer-feedback related data by NPS to yield customer-feedback related data having normalized NPS.

Furthermore, in accordance with some embodiments of the present disclosure, before calculating the CFRS normalizing the customer-feedback related data by NPS to yield customer-feedback related data having normalized NPS.

Furthermore, in accordance with some embodiments of the present disclosure, the customer-feedback related data by NPS may be normalized based on formula I:

$$\hat{X} [ : , i ] = \frac{X [ : , i ] - min ( X [ : , i ] )}{max ( X [ : , i ] ) - min ( X [ : , i ] )} \qquad ( I )$$

whereby:
\hat{X}[:,i] is a normalized NPS score,
x[:,i] is NPS score of current feedback instance,
min(X[:,i]) is minimum NPS score within all the feedback instances for respective agent
max(X[:,i]) is maximum NPS score within all the feedback instances for an agent.

Furthermore, in accordance with some embodiments of the present disclosure, the computerized-method may further include identifying impacted categories in the customer-feedback related data having normalized NPS by counting feedback comments in each category.

Furthermore, in accordance with some embodiments of the present disclosure, the first one or more groups and the second one or more groups may include: focus area, behavior and knowledge base artifacts.

Furthermore, in accordance with some embodiments of the present disclosure, the web application for managing coaching sessions may be a cloud-based application which may be implemented as a workflow and having distributed component units and the web application may interact with a service to coordinate work across the distributed component units.

Furthermore, in accordance with some embodiments of the present disclosure, the retrieved mapping between categories and one or more groups may be preconfigured by a user of the web application for managing coaching sessions.

Furthermore, in accordance with some embodiments of the present disclosure, the operated algorithm may be k-Nearest neighbors algorithm.

Furthermore, in accordance with some embodiments of the present disclosure, the detecting of the preconfigured number of categories having highest variance may be operated by an isolation forest algorithm.

Furthermore, in accordance with some embodiments of the present disclosure, upon user selection of the determined second one or more groups presenting the maximum CFRS and a notification that maximum CFRS achieved.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIGS. 1A-1B schematically illustrates a high-level diagram of a computerized-system for generating a coaching session having coaching content related to customer experience, in a web application for managing coaching sessions, in accordance with some embodiments of the present invention;

FIG. 2 is a schematic flowchart of an operation of generating a coaching session having coaching content related to customer experience, in a web application for managing coaching sessions, in accordance with some embodiments of the present invention;

FIG. 3A schematically illustrates an implementation of a coaching session architecture, in accordance with some embodiments of the present invention;

FIG. 3B schematically illustrates an implementation of a coaching session architecture for generating a coaching session having coaching content related to customer experience, in a web application for managing coaching sessions, in accordance with some embodiments of the present invention;

FIGS. 4A-4B schematically illustrates a workflow of creating Customer Feedback Relevance Score (CFRS), in accordance with some embodiments of the present invention;

FIG. 5 is a workflow of an operation for generating a coaching session having coaching content related to customer experience, in a web application for managing coaching sessions, in accordance with some embodiments of the present invention;

FIGS. 6A-6C are examples of Graphical User Interface (GUI) screenshots in a web application for managing coaching sessions, in accordance with some embodiments of the present invention; and

FIGS. 7A-7D show simulation and test results of implementation of a coaching session generated having coaching content related to customer experience, in a web application for managing coaching sessions, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Existing coaching for agents in contact centers, focuses on agent performance metrics values and its manual association with coaching contents, e.g., focus areas and behavior. However, customer experience should also be taken into consideration. Therefore, there is a need for a system and method for generating a coaching session having coaching content related to customer experience, in a web application for managing coaching sessions.

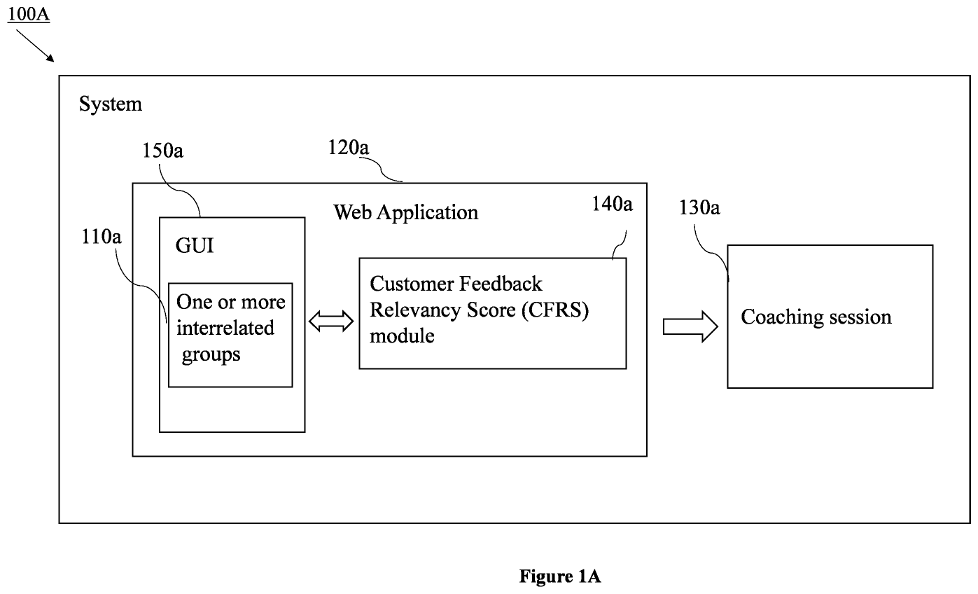

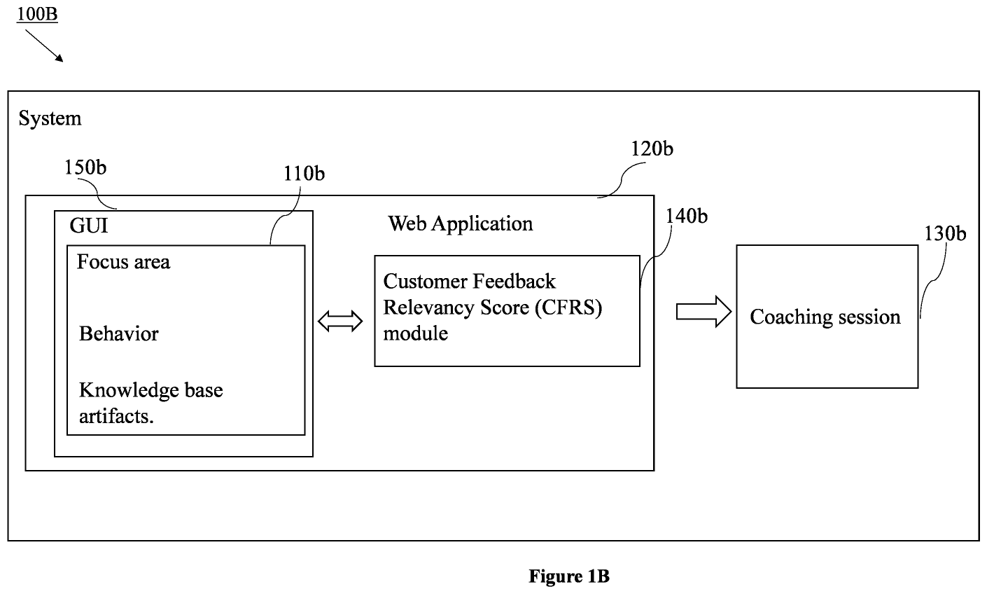

FIGS. 1A-1B schematically illustrate a high-level diagram of a computerized-system for generating a coaching session having coaching content related to customer experience, in a web application for managing coaching sessions, in accordance with some embodiments of the present invention.

According to some embodiments of the present disclosure, in a computerized-system, such as system 100A, the system may run a web application 120a for managing coaching sessions. The web application 120a for managing coaching sessions may accept coaching content having one or more interrelated groups 110a to create a coaching session 130a for an agent in a contact center.

According to some embodiments of the present disclosure, based on received user selection of coaching content having first one or more groups, via a graphical User Interface (GUI) 150a, for an agent, a module, such as Customer Feedback Relevancy Score (CFRS) module 140a may be operated.

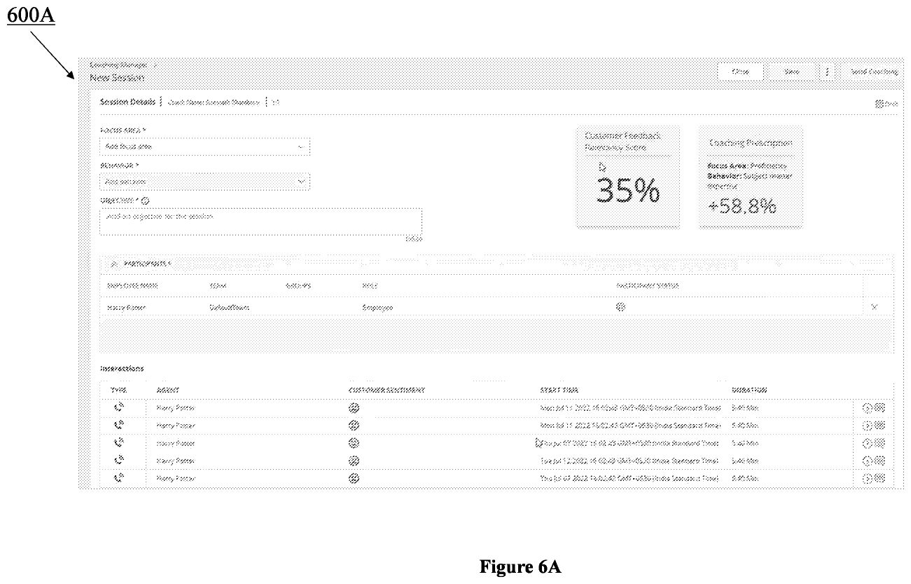

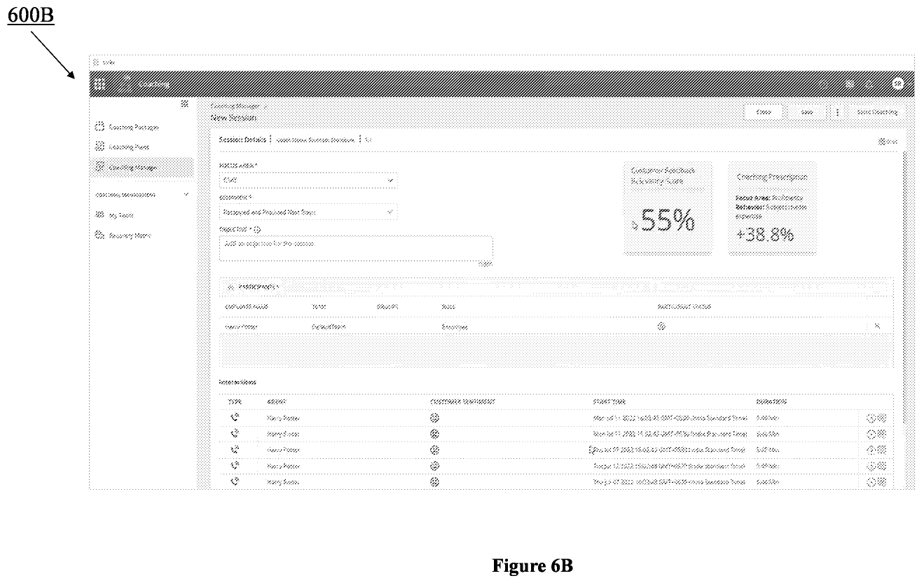

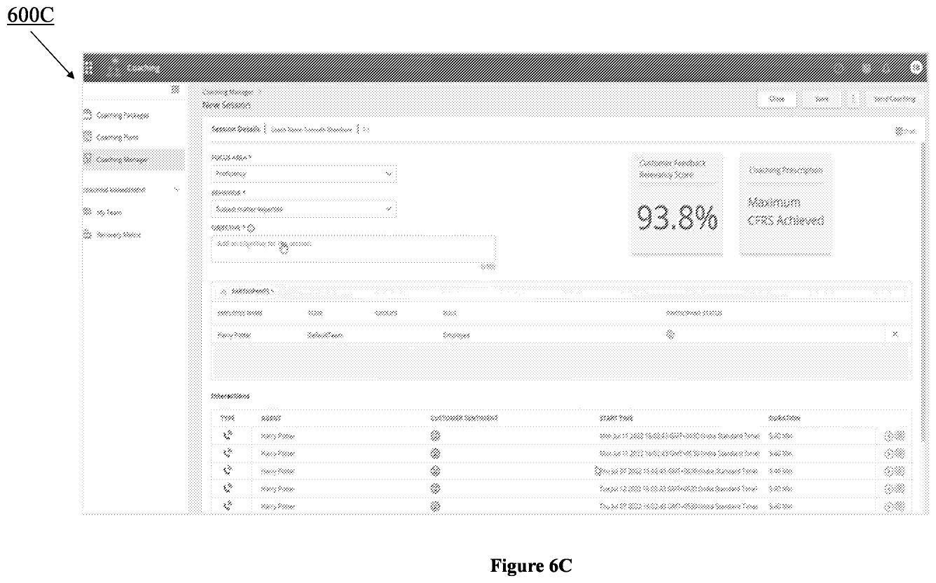

According to some embodiments of the present disclosure, the CFRS module 140a may include calculating a CFRS and presenting the calculated CFRS via the GUI 150a, for example, as shown in FIGS. 6A-6C. The value of the CFRS may indicate the relevancy of user selection of coaching content having the first one or more groups to customer experience (CX).

According to some embodiments of the present disclosure, the CFRS module 140a may further include determining second one or more groups of coaching content to maximize the value of the CFRS and may present the second one or more groups via the GUI 150a, as shown in FIGS. 6A-6B as well as an increase in the calculated CFRS to reach a maximum CFRS to improve CX. The second one or more groups may include focus area, behavior and knowledge base artifacts, 110b in FIG. 1B, for example, as shown in FIGS. 6A-6C.

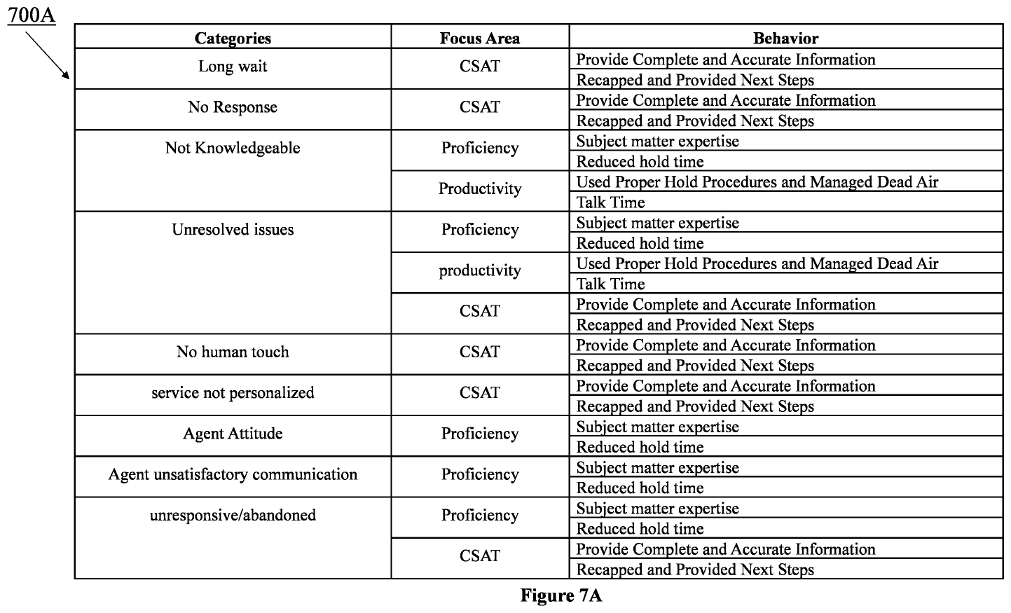

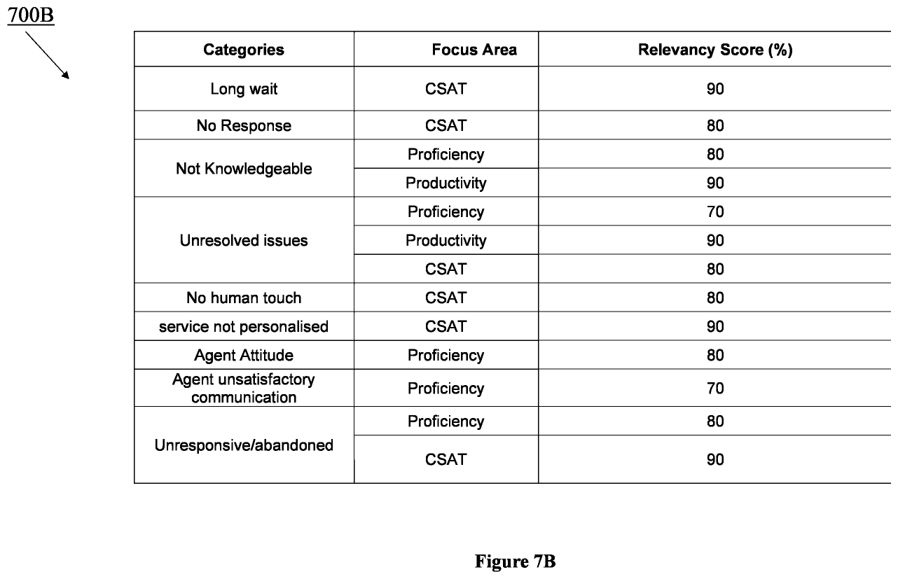

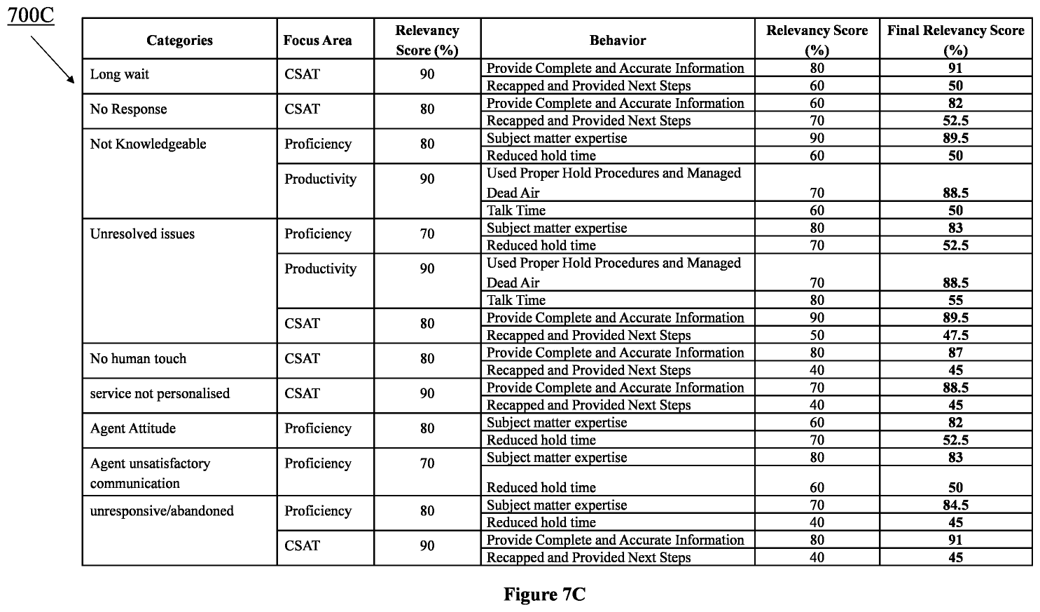

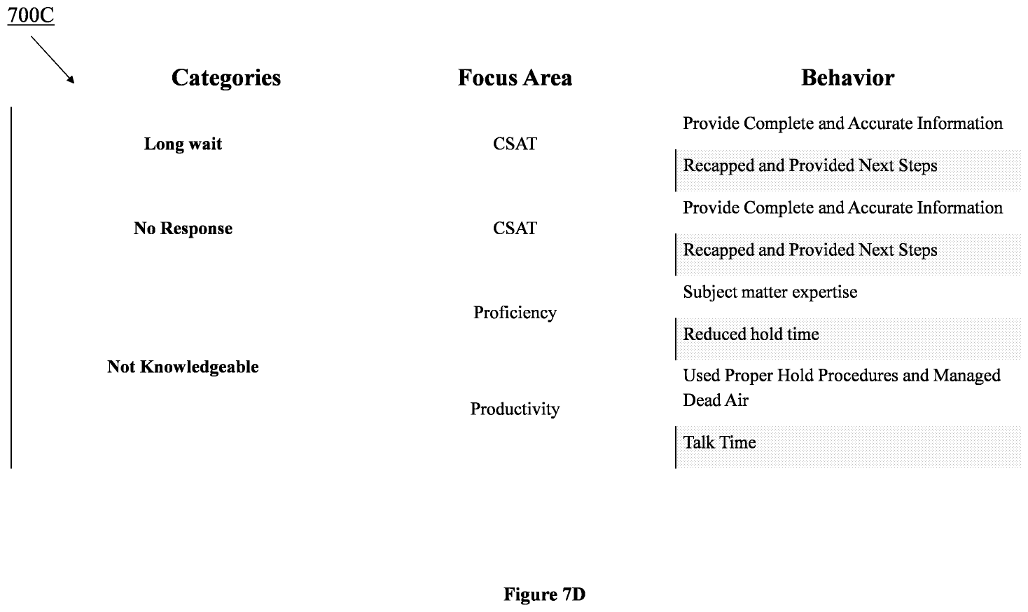

According to some embodiments of the present disclosure, focus area may be for example, CSAT, proficiency, and the like, as shown in table 700A in FIG. 7A.

According to some embodiments of the present disclosure, the CFRS module 140a may further include retrieving customer-feedback related data during a preconfigured period for the agent from a feedback-management component (not shown). Then, extracting parameters from the customer-feedback related data for each feedback. The parameters may include at least one of: feedback comment, associated Net promoter score (NPS), assigned categories, customer and agent details and associated interaction identifier.

According to some embodiments of the present disclosure, the CFRS module 140a may further include retrieving mapping between categories and the first one or more groups and operating an algorithm to calculate a CFRS for each category based on the extracted parameters based on the retrieved mapping, as shown in table 700A in FIG. 7A. The operated algorithm may be k-Nearest neighbors algorithm.

According to some embodiments of the present disclosure, occurrences of each category may be counted to determine a median number for each category and detect a preconfigured number of categories having highest variance in number of occurrences to yield impacted categories. The impact categories may indicate categories that require to be included in the generated coaching session to improve customer service.

According to some embodiments of the present disclosure, the CFRS may be calculated by formula II:

$$CFRS = \frac{{\sum }_{n}^{i = 0} ( {ContentRelevance}_{i} * {ContentWeightage}_{i} )}{100} \qquad ( II )$$

whereby:
n is the number of contents,
content relevance is a relevance value for content, and
content Weightage is weightage configured for a selected content.

According to some embodiments of the present disclosure, the CFRS module 140a may further include sorting interactions associated with the impacted categories based on NPS score and extracting a preconfigured number of associated interactions which have an NPS score below a preconfigured threshold and having lowest NPS score to be added to the generated coaching session.

According to some embodiments of the present disclosure, before calculating the value of the CFRS, normalizing the customer-feedback related data by NPS to yield customer-feedback related data having normalized NPS.

According to some embodiments of the present disclosure, the customer-feedback related data by NPS may be normalized based on formula I:

$$\hat{X} [ : , i ] = \frac{X [ : , i ] - min ( X [ : , i ] )}{max ( X [ : , i ] ) - min ( X [ : , i ] )} \qquad ( I )$$

whereby
\hat{X}[:,i] is a normalized NPS score,
X[:,i] is NPS score of current feedback instance,
min(X[:,i]) is minimum NPS score within all the feedback instances for respective agent
max(X[:,i]) is maximum NPS score within all the feedback instances for an agent.

According to some embodiments of the present disclosure, impacted categories in the customer-feedback related data having normalized NPS may be identified by counting feedback comments in each category.

According to some embodiments of the present disclosure, the first one or more groups and the second one or more groups may include: focus area, behavior and knowledgebase artifacts, for example, as shown in FIGS. 7A-7b.

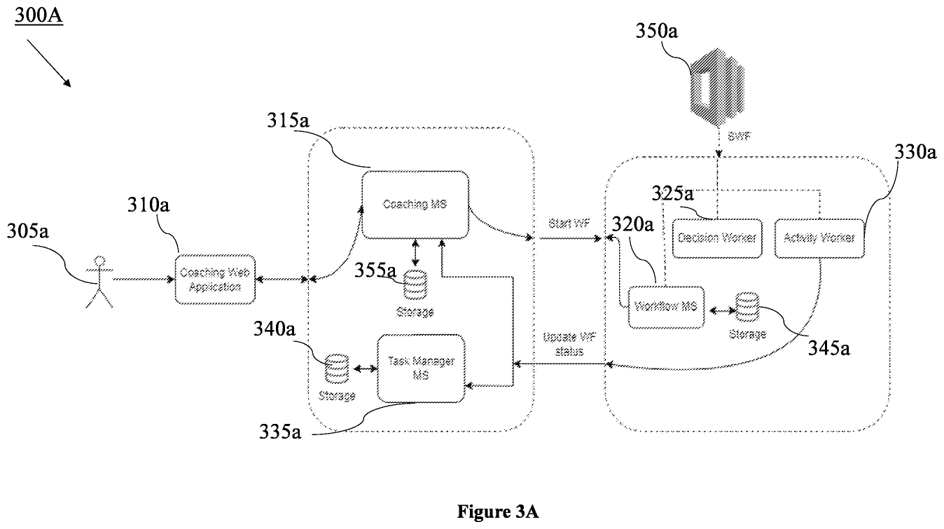

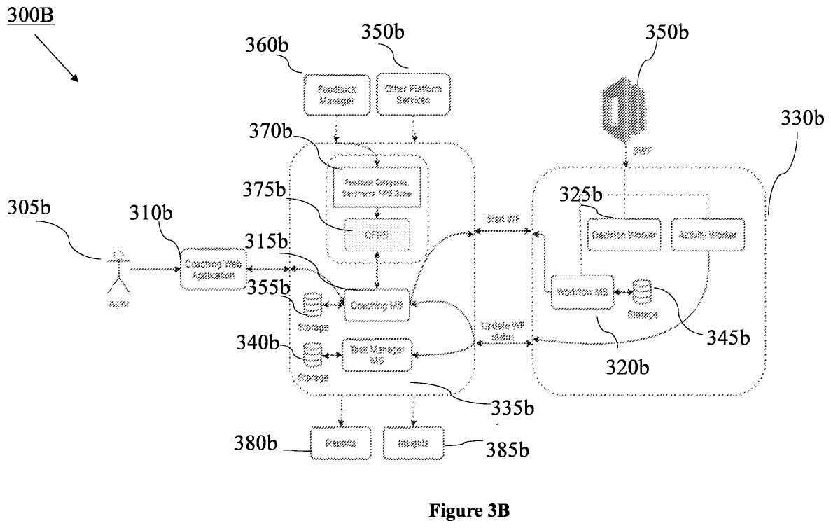

According to some embodiments of the present disclosure, the web application, such as web application 120a and 120b for managing coaching sessions may be a cloud-based application which is implemented as a workflow and having distributed component units. The web application may be interacting with a service to coordinate work across the distributed component units, for example as shown in FIG. 3B.

According to some embodiments of the present disclosure, the retrieved mapping between categories and one or more groups may be preconfigured by a user of the web application 120a for managing coaching sessions. For example, as shown in table 700A in FIG. 7A.

According to some embodiments of the present disclosure, upon user selection of the determined second one or more groups, via the GUI 150a, for example, as shown in FIG. 6B, the maximum CFRS and a notification that maximum CFRS achieved may be presented, as shown in FIG. 6C.

According to some embodiments of the present disclosure, upon user selection via the GUI generating a coaching session. A user may select the determined one or more groups as shown in FIGS. 6A-6B or select the coaching content that maximizes the CFRS, as shown in FIG. 6C.

According to some embodiments of the present disclosure, optionally, the generated coaching session may be automatically scheduled and operated for the agent.

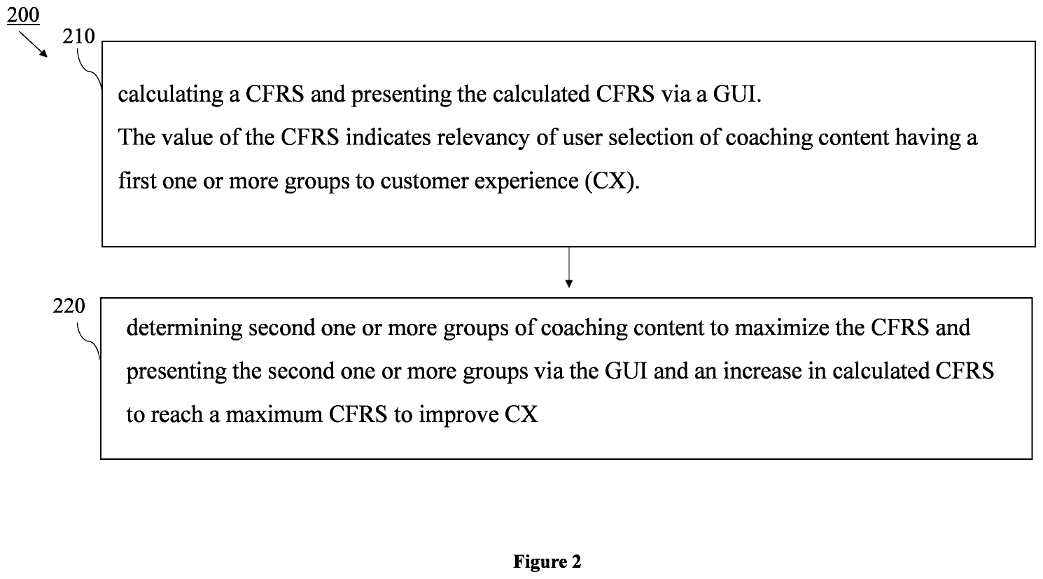

FIG. 2 is a schematic flowchart 200 of an operation of generating a coaching session having coaching content related to customer experience, in a web application for managing coaching sessions, in accordance with some embodiments of the present invention.

According to some embodiments of the present disclosure, operation 210 comprising calculating a CFRS and presenting the calculated CFRS via a GUI. The value of the CFRS indicates relevancy of user selection of coaching content having a first one or more groups to customer experience (CX). For example, as shown in FIG. 6A.

According to some embodiments of the present disclosure, operation 220 comprising determining second one or more groups of coaching content to maximize the CFRS and presenting the second one or more groups via the GUI and an increase in calculated CFRS to reach a maximum CFRS to improve CX. For example, as shown in FIG. 6B.

According to some embodiments of the present disclosure, upon user selection via the GUI generating a coaching session.

According to some embodiments of the present disclosure, optionally, the generated coaching session may be automatically scheduled and operated for the agent.

FIG. 3A schematically illustrates an implementation of a coaching session architecture 300A.

Currently, a user, such as a coach 305a, in a contact center, uses a coaching web application 310a, for creating coaching sessions for agents. The coach creates coaching sessions based on agent's performance metrics, strength and weaknesses, productivity and proficiency measures. The coach 305a logs into the coaching application 310a and creates coaching sessions for one or more agents. While creating a session for an agent the coach selects a focus area, such as ‘Customer Satisfaction Score (CSAT)’ and corresponding behavior, such as ‘recapped and provided next steps’. Also, the coach 305a can select past interactions of the agents and attach knowledge-based artifacts for the session for the agent's reference. Other participants may be added to the created coaching session.

A coaching Microservice (MS) 315a is used for the creation of the coaching sessions, which in turn interacts with other services to ensure the entire flow of session creation is completed. This service, i.e., coaching MS 315a, accepts the data from the coaching web application 310a and creates a coaching session in the system. The accepted data to create the coaching session may be coaching content having one or more interrelated groups and may be stored in a storage 355a.

A workflow service, such as workflow MS 320a assists in creating and managing the workflows for every coaching session. The workflows may be implemented as Amazon Web Services (AWS) Simple Workflow Service (SWF) workflows. The data that is sent to a workflow manager service 320a from a coaching manager service of coaching MS 315a is a workflow configuration which is a workflow manager service that accepts the configuration for creating workflows for a coaching session, e.g., focus area and behavior and workflow details to create a workflow in AWS SWF using the specified configuration. The data of the accepted configuration and workflow details may be stored in a storage 345a.

A decision worker service 325a assists in executing the steps of the workflow to manage the entire journey of a coaching session through different states. An activity service 330a includes business logic present at each step of the coaching workflow. A task manager service, such as task manager MS 335a assists in holding the state of the coaching session workflows at every step. This service accepts the details to create and update a task corresponding to every workflow created in the workflows, e.g., AWS SWF. The accepted details to create and update a task may be coaching content having one or more interrelated groups and it may be stored in a storage 335a.

Workflow 350a, such as AWS SWF workflow service is used to manage the journey of coaching sessions through different states, it primarily includes decision worker 325a and activity worker 330a.

However, the selections of focus area, behavior, interactions, and file attachments is performed by the coach manually without any indication as to their relevancy to customer experience. Hence, the selection is subjective in nature and depends on the skills, visibility and judgement of the coach. Moreover, the process of coaching session creation is currently centered around improving the agent performance rather than improving customer experience (CX) directly by focusing on needs and feedback from customers. This indirect approach leaves a gap wide open to empathize with customers feedback who in actual will be interacting with contact center.

Accordingly, there is a need for computerized-system and computerized-method for generating a coaching session having coaching content related to customer experience, in a web application for managing coaching sessions.

FIG. 3B schematically illustrates an implementation of a coaching session architecture 300B for generating a coaching session having coaching content related to customer experience, in a web application for managing coaching sessions, in accordance with some embodiments of the present invention.

According to some embodiments of the present disclosure, coaching session architecture 300B may include all the components of coaching session architecture 300A, which is a coaching web application 310b, such as web application 120a in FIG. 1 or 120b in FIG. 1B, a coaching Microservice (MS) 315b, a workflow MS 320b, a decision worker service 325b, an activity service 330b, a task manager service 335b, storages 340b, 345b, 355b and a workflow 350b.

According to some embodiments of the present disclosure, other platform services 350b may include User Hub, Tenant Manager, Notification Service and the like.

According to some embodiments of the present disclosure, feedback manager 360b may by a feedback management component. The feedback manager 360b may have all the information about customer feedback and its analytics. For example, detailed verbatim feedback comment, NPS score given by the customer, the customer and agent details, and the categories identified based on the feedback comment.

According to some embodiments of the present disclosure, feedback categories, and NPS score 370b, is the information that may be extracted from the feedback management service, such as feedback manager 360b. The NPS score is associated with feedback, categories tagged to feedback through analytics and interaction associated with that feedback.

According to some embodiments of the present disclosure, a module, such as Customer Feedback Relevancy Score (CFRS) module 365 and such as CFRS module 140a in FIG. 1A and such as CFRS module 140b in FIG. 1B may receive information, such as feedback categories, and NPS score 370b to calculate a CFRS and present it via a GUI, as shown in FIG. 6B. The value of the CFRS indicates relevancy of user selection of coaching content having the first one or more groups to customer experience (CX).

According to some embodiments of the present disclosure, the CFRS may be forwarded to a coaching MS 315b which also accepts the data from the coaching web application 310b i.e., coaching content having one or more interrelated groups and creates a coaching session in a system, such as system 100A in FIG. 1A and such as system 100B in FIG. 1B.

According to some embodiments of the present disclosure, a report 380b may be generated which includes Coaching Sessions by Topic, Per team, Coaching Sessions by focus areas and behavior.

According to some embodiments of the present disclosure, insights 385b may be generated such as insights on recurring focus areas for coaching, recurring coaching done for certain agent.

According to some embodiments of the present disclosure, optionally, the generated coaching session may be automatically scheduled and operated for the agent.

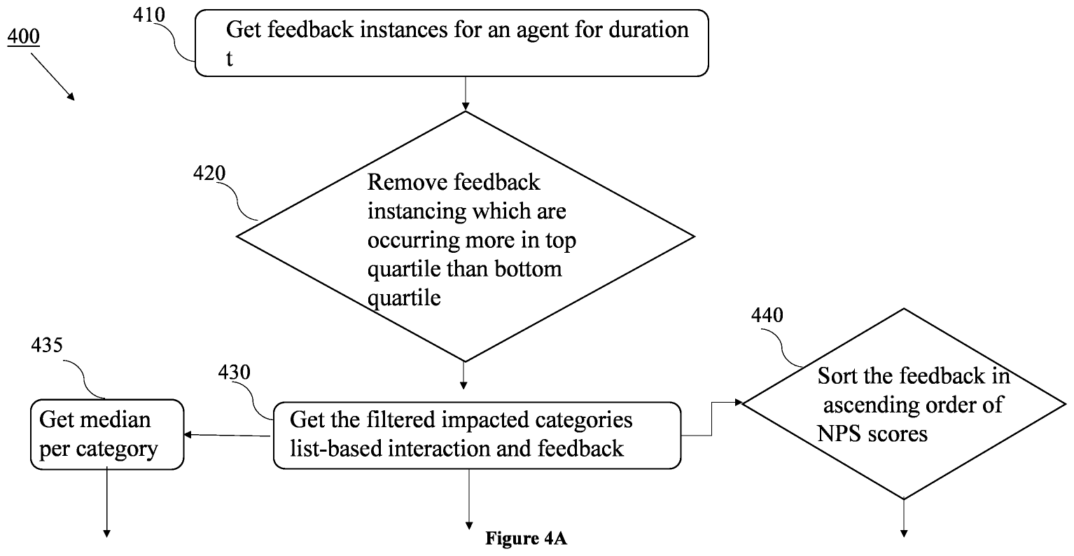

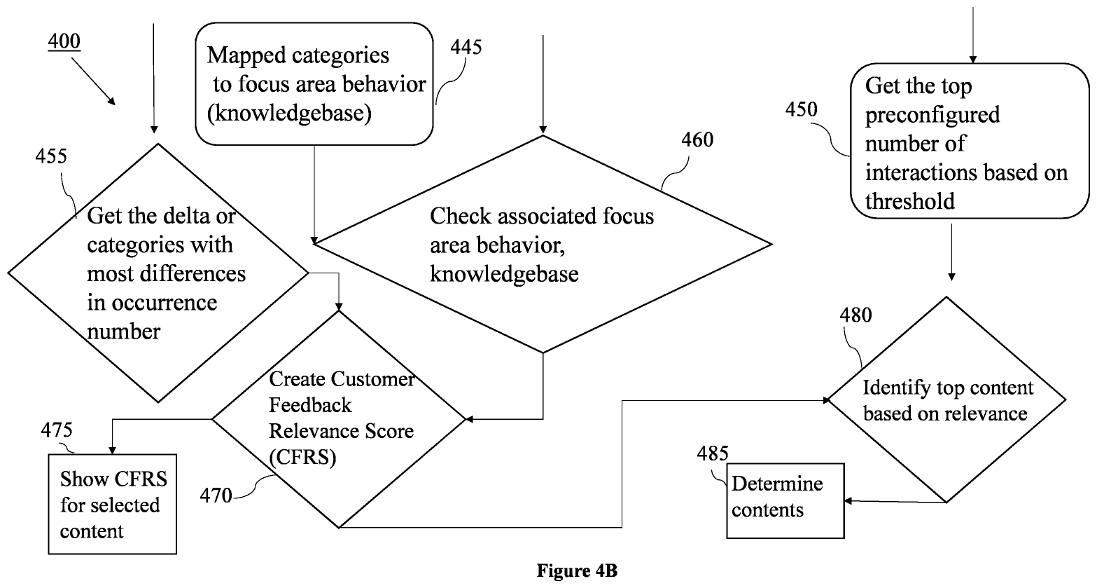

FIGS. 4A-4B schematically illustrates a workflow 400 of creating Customer Feedback Relevance Score (CFRS), in accordance with some embodiments of the present invention.

According to some embodiments of the present disclosure, a module, such as CFRS module 140a in FIG. 1A may include get feedback instances for an agent for duration ‘t’ 410, which means retrieving customer-feedback related data during a preconfigured period for the agent per interaction from a feedback-management component.

According to some embodiments of the present disclosure, for every agent id and a preconfigured duration ‘t’, e.g., a week, a daily scheduled job in a system, such as system 100A in FIG. 1A may send a request for feedback details to a feedback-management component, e.g., feedback-management Application Programming Interface (API) for agent ‘a’. The received response may be cleansed for any null values or data miss. The valid data which includes feedback details such as verbatim feedback, NPS score, categories identified from feedback, customer and agent details may be forwarded for further process by CFRS module.

According to some embodiments of the present disclosure, the CFRS module may remove feedback instancing which are occurring more in top quartile than bottom quartile 420, which means based on NPS score, the data may be normalized and feedbacks having biased promoter or detractor details may be removed.

According to some embodiments of the present disclosure, normalizing the customer-feedback related data by NPS to yield customer-feedback related data having normalized NPS. The customer-feedback related data by NPS is normalized based on formula I:

$$\hat{X} [ : , i ] = \frac{X [ : , i ] - min ( X [ : , i ] )}{max ( X [ : , i ] ) - min ( X [ : , i ] )} \qquad ( I )$$

whereby
\hat{X}[:,i] is a normalized NPS score,
X[:,i] is NPS score of current feedback instance,
min(X[:,i]) is minimum NPS score within all the feedback instances for respective agent,
max(X[:i]) is maximum NPS score within all the feedback instances for an agent.

According to some embodiments of the present disclosure, the normalized value for NPS, i.e., norm (NPS) may be checked within an identified range to extract the feedbacks which are within the range. The range may be identified, i.e., top quartile than bottom quartile, by identifying maximum NPS and minimum NPS for all feedbacks for agent ‘a’ for duration ‘t’ and then calculating a normalized value of NPS by formula I for each feedback. Then, using a preconfigured minimum distance threshold and a preconfigured maximum distance threshold, e.g., distₘᵢₙ=0.2 and distₘₐₓ=0.8, to check if norm (NPS) is therebetween. Feedbacks which are not in the range may be rejected, such that a normalized and filtered list of feedback details is yielded.

According to some embodiments of the present disclosure, the CFRS module may get the filtered impacted categories list-based interaction and feedback 430 which means retrieving mapping between categories and the first one or more groups and operating an algorithm to calculate a CFRS for each category based on the extracted parameters based on the retrieved mapping.

According to some embodiments of the present disclosure, the CFRS may get median number per category 435 by counting occurrences of each category to determine a median number for each category and detecting a preconfigured number of categories having highest variance to yield the impacted categories.

According to some embodiments of the present disclosure, the median number of occurrences for each category for duration ‘t’ and for duration ‘t−1’ may be received by getting the categories and associated count from map(category(count, feedbackIds)). Map denotes key-value pair. The category is key, and a combination of count and feedback id is value. This has summarized view for each category and associated feedback count and ids. and then calculating a median value on count for each category (category, median (category_count)), where there's a key-value pair for each category and associated median value.

According to some embodiments of the present disclosure, the CFRS may sort the feedback of NPS scores 440. The interactions associated with impacted categories based on NPS scores may be sorted, e.g., lower NPS score to high NPS score.

According to some embodiments of the present disclosure, the CFRS may get the lowest preconfigured number of interactions based on threshold, by extracting a preconfigured number of associated interactions which have an NPS score below a preconfigured threshold and having lowest NPS score to be added to the generated coaching session.

According to some embodiments of the present disclosure, mapped categories to focus area behavior (knowledgebase) 445 may be retrieved. A mapping between different categories received from feedback management and focus areas and behaviors used in coaching may be preconfigured, for example, as shown in table 700D, in FIG. 7D.

According to some embodiments of the present disclosure, get the delta or categories with most differences in occurrence number 455. Identifying delta and common set of categories in terms of number of occurrences change between duration ‘t’ and ‘t−1’. Duration ‘t’ and ‘t−1’ denote feedback data for the duration. Duration ‘t−1’ may be used to check variance.

According to some embodiments of the present disclosure, the detecting of the preconfigured number of categories having highest variance may be operated by an isolation forest algorithm, in which category median count for duration ‘t’ and category median count for duration ‘t−1’ may be merged to a set on which the isolation forest algorithm may be applied to yield categories having most variance.

According to some embodiments of the present disclosure, repeating recursively of randomly selecting a data tuple with category_count ‘p’ to divide the set into left and right sub tree with data tuple's category count lower than ‘p’, until either the current node has only one sample or all the values at the current node have the same values. Then, checking the isolation score I_{score}, such that when the isolation score I_{score} is close to ‘1’ then the category has a high variance, when the isolation score I_{score} is less than ‘0.5’ then the category is normal and when the isolation score I_{score} is close to ‘0.5’ then the category has no high variance. Then, getting all the categories having high variance which are the impacted categories. An isolation score I_{score} may be considered close to ‘1’ when it is in the range of ‘0.8’ to ‘1’.

According to some embodiments of the present disclosure, operating an algorithm to calculate a CFRS for each category based on the extracted parameters based on the retrieved mapping by checking associated focus area, behavior, knowledgebase 460.

According to some embodiments of the present disclosure, based on mapped focus area, behavior, interactions and knowledgebase articles and the filtered list of impacted categories, a relevance score to the impacted categories may be calculated for each coaching content such as focus area, behavior, interactions and knowledgebase artifacts.

According to some embodiments of the present disclosure, the operated algorithm may be k-Nearest Neighbors K-NN algorithm. The K-NN algorithm may be operated by repeating the following for all content categories: using configured k neighbors, e.g., 10, then, calculating distance of all k neigbours for identified categories from map(Category,(count, feedbackIds)). Category is key and a combination of count and feedback id is value. Thus, getting a summarized view for each category and associated feedback count and ids. Then, associated focus area-behaviour mapping. Then, taking the nearest neighbors and counting the categories, i.e., focus area-behaviors. Assigning new data point for identified categories. Repeat model among all mappings. Get the relevance score, i.e., distance for all the content mappings. There may be a focus area-behavior mapping configured in the coaching app. A distance for each mapping may be checked from the results e.g., focus area-behavior. Then, storing the relevance score per agent per content category in a database.

According to some embodiments of the present disclosure, get the top preconfigured number of interactions based on threshold 450 with lowest NPS score, before identifying top content based on relevance 480. A threshold may be configured for NPS score to be used when extracting a preconfigured number of associated interactions which have an NPS score below a preconfigured threshold and having lowest NPS score to be added to the generated coaching session.

According to some embodiments of the present disclosure, each time a coaching content is selected or changed via a GUI, create Customer Feedback Relevance Score (CFRS) 470 to present the CFRS for the selected content 475 and select content to the generated coaching session and then, identify top content based on relevance 480 to determine contents 485 of the generated coaching session.

According to some embodiments of the present disclosure, the CFRS may be calculated for a coaching content for the impacted categories with content relevance score thereof and configurable weightage associated with each content by formula II:

$$CFRS = \frac{{\sum }_{n}^{i = 0} ( {ContentRelevance}_{i} * {ContentWeightage}_{i} )}{100}$$

whereby:
n is the number of contents,
content relevance is a relevance value for content, and
contentWeightage is weightage configured for a selected content.

According to some embodiments of the present disclosure, when a user, such as a coach opens a create coaching page in a coaching web application, such as web application 120a in FIG. 1 or web application 120b, in FIG. 1B, for a selected agent the web application may operate in parallel: (i) prepopulates interactions identified, e.g., top preconfigured number of interactions based on threshold 450 with lowest NPS score, (ii) runtime calculates and displays CFRS value based on create CFRS 470. Here only interactions are pre-populated, the CFRS may be calculated only for interactions and associated weightage, as shown in formula II; (iii) determine contents 485 and get improvement percentage difference to achieve maximum CFRS, as shown for example, in FIG. 6B.

According to some embodiments of the present disclosure, when the coach selects or changes focus area, behavior or knowledgebase article to attach, then the web application may operate in parallel: (i) runtime calculates and displays CFRS value based on create CFRS 470 and based on selected categories or knowledgebase and pre-populated interactions considering weightage for each category; and (ii) determine contents 485 and get improvement percentage difference to achieve maximum CFRS, as shown for example, in FIG. 6B.

According to some embodiments of the present disclosure, identify top content based on relevance 480 may include identifying the top set of content combination which may provide a maximum CFRS value.

According to some embodiments of the present disclosure, the top content based relevance to customer experience may be identified by getting all the impacted categories of operation 430 and the identified interactions of operation 450 to calculate CFRS of interaction based on formula II above. Then, initializing the following variables by: Set Max(focus area, behavior)=0, FocusAreaₘₐₓ=“ ” and Behaviorₘₐₓ=“ ”. After processing these variable will have result of focusArea and behavior combination respectively resulting in maximum CFRS.

For the impacted categories get focus area with highest relevance score calculated in operation 460, for example, as shown in FIG. 7B. For the identified focus area, i.e. operation 445, get the mapped behavior e.g., FIG. 7A with highest relevance score calculated in operation 460, as shown in FIG. 7C. Then, calculating current CFRS for focus area and mapped behavior based on CFRS value.

According to some embodiments of the present disclosure, when current CFRS is higher than Max((focus area, behavior) then Max(focus area, behavior)=current CFRS, FocusAreaₘₐₓ=current focus area and Behaviorₘₐₓ=current behavior. Thus, getting max CFRS associated combination of focus area-behavior mapping by iterating over identified focus area-behaviors. Otherwise, moving to the next item in the iteration list.

According to some embodiments of the present disclosure, getting the knowledgebase article with maximum relevance score which has been identified in operation 460. Then, calculating maximum CFRS by formula III:

$${CFRS}_{max} = Max ( focus area , behavior ) + {CFRS}_{interaction} + {CFRS}_{KB}$$

whereby:
CFRSₘₐₓ₋ Denotes the maximum CFRS value achieved,
Max(focus area, behavior) is Maximum CFRS value achieved for focus-area and behavior combination,
CFRS_{interaction} CFRS score achieved for interaction, and
CFRS_{KB} is a CFRS score that has been achieved for the knowledge base.

According to some embodiments of the present disclosure, displaying the difference between maximum CFRS and current CFRS as to improve CFRS, the maximum focus area, and the maximum behavior, as shown in FIG. 6B. The difference is a percentage by which first group or groups may be improved to align with maximum achievable CFRS.

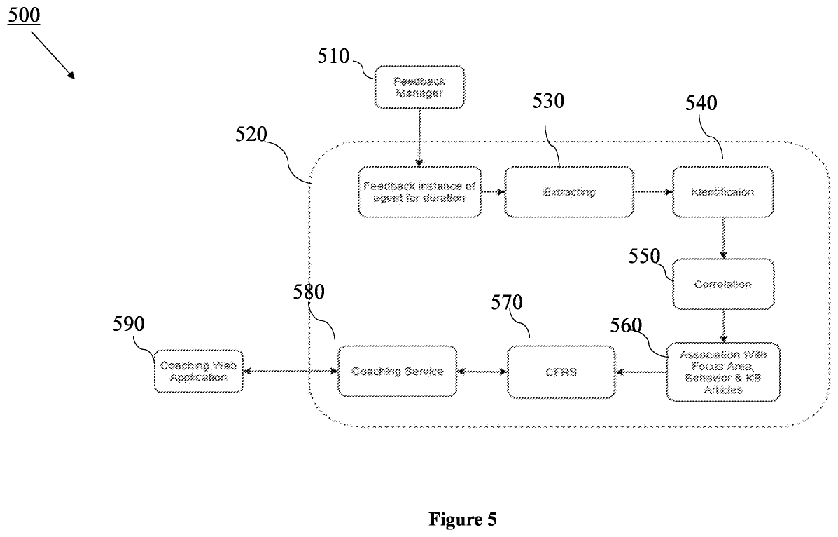

FIG. 5 is a workflow 500 of an operation for generating a coaching session having coaching content related to customer experience, in a web application for managing coaching sessions, in accordance with some embodiments of the present invention.

According to some embodiments of the present disclosure, a feedback manager 510 may provide a feedback management service, including retrieving information related to feedback, NPS, and its analytics. The feedback management service may extract parameters in a preconfigured duration, from the customer-feedback related data e.g., a feedback instance of agent for duration 520, for each feedback. The parameters may include at least one of: feedback comment, associated Net promoter score (NPS), assigned categories, customer and agent details and associated interaction identifier.

According to some embodiments of the present disclosure, feedback comments are comments provided by customers as a part of a feedback to an interaction with an agent. These comments may be textual or voice type, and are detailed feedback given by the customer on a given issue or interaction.

According to some embodiments of the present disclosure, the feedback manager 510 may use the feedback comments to extract insights through feedback analytics. The extracted insight through feedback analytics may include categories such as ‘Long wait’, ‘Not Knowledgeable’, ‘Unresolved issues’, ‘Agent Attitude’, ‘No human touch’, ‘service not personalized’ and the like.

According to some embodiments of the present disclosure, the Net promoter score (NPS) signifies whether the customer will be Detractors (NPS Range 0-3), Neutral (4-6), Passive (Range 7-8), Promoters (Range 9-10). This information may help to get impacted interaction of agent.

According to some embodiments of the present disclosure, customer and agent details include customer details such as name and feedback time details, the agent details include name and userId for whom the feedback was given.

According to some embodiments of the present disclosure, categories associated with feedback may be extracted from the feedback given by customers by algorithms of feedback management 510 which are using analytics. For example, ‘Long wait’, ‘Not Knowledgeable’ and the like as shown in FIG. 7A.

According to some embodiments of the present disclosure, extracting 530 may be operated by extracting feedback instances using machine learning algorithms. For example, Min-Max normalization, as explained in detail in operation 455 in FIG. 4B.

According to some embodiments of the present disclosure, identification may be operated by identifying most variable categories from the past set of duration using a machine learning algorithm. For example, Isolation Forest of interactions based on the NPS threshold. Then, correlation may be operated by correlating available categories with Focus area, behavior, and Knowledge base.

According to some embodiments of the present disclosure, association with Focus area, behavior and knowledgebase articles may be operated based on the output of the correlation 550.

According to some embodiments of the present disclosure, a module, such as CFRS module 570, and such as CFRS module 140a in FIG. 1A may calculate a Customer Feedback Relevancy Score (CFRS) based on weightage for the Focus Area, Behavior, and knowledgebase and accordingly identify and determine the content of the generated coaching session, based on relevance to customer experience (CX).

According to some embodiments of the present disclosure, a coaching service 580 may be responsible for all session-related activities. When the coaching session is in process of creation, a module, such as CFRS module, may use the calculated CFRS based on the selected content and determine the action items to increase the CFRS.

According to some embodiments of the present disclosure, coaching web application 590, such as web application 120a in FIG. 1A may be used as an interface for managing coaching.

FIGS. 6A-6C are examples of Graphical User Interface (GUI) screenshots in a web application for managing coaching sessions, in accordance with some embodiments of the present invention.

According to some embodiments of the present disclosure, GUI 600A is an example of a default coaching creation page which provides the current CFRS value and the maximum CFRS value which can be achieved with the determined contents, as shown in element 485 in FIG. 4. The coaching creation may auto populate the top preconfigured number of interactions identified for the improvement based on their relevancy score, as shown in element 450 in FIG. 4.

According to some embodiments of the present disclosure, GUI 600B is an example of runtime CFRS calculation based on variable content selected by coach and determined maximum CFRS yet to achieve.

According to some embodiments of the present disclosure, GUI 600C is an example of alignment of content selected by a coach with maximum CFRS score, which indicates that the content in coaching session covers the categories identified based customer feedback to the maximum value.

FIGS. 7A-7D show simulation and test results of implementation of generating a coaching session having coaching content related to customer experience, in a web application for managing coaching sessions, in accordance with some embodiments of the present invention.

According to some embodiments of the present disclosure, table 700A is an example of focus areas and behaviors associated with respective categories. This mapping may be configurable.

According to some embodiments of the present disclosure, table 700B is an example of focus areas associated with respective categories and their relevancy score in percentage. The relevancy score may be calculated by a module, such as CFRS module 140a in FIG. 1A.

According to some embodiments of the present disclosure, table 700C is an example of behaviors associated with respective categories and focus areas and their relevancy score in percentage. The CFRS, i.e., final relevancy score may be calculated for best combination of coaching session content. The final calculation may be derived based on formula II from a preconfigured weightage given to different categories and associated relevancy scores. For example, focus area 30%, behavior 25%, interactions 25%, knowledgebase 20%.

According to some embodiments of the present disclosure, table 700D is an example of a configuration of mapping between different categories received from feedback management and focus areas and behaviors used in coaching.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for generating a coaching session having coaching content related to customer experience, in a web application for managing coaching sessions, said computerized-method comprising:
in a system that is running the web application for managing coaching sessions, said web application for managing coaching sessions accepts coaching content having one or more interrelated groups to create a coaching session,
based on received user selection of coaching content having first one or more groups, via a graphical User Interface (GUI), for an agent, operating a Customer Feedback Relevancy Score (CFRS) module, said CFRS module comprising:
(i) calculating a CFRS and presenting the calculated CFRS via the GUI, wherein the CFRS indicates relevancy of user selection of coaching content having the first one or more groups to customer experience (CX); and
(ii) determining second one or more groups of coaching content to maximize the CFRS and presenting the second one or more groups via the GUI and an increase in calculated CFRS to reach a maximum CFRS to improve CX.

2. The computerized-method of claim 1, wherein said CFRS module further comprising:
(i) retrieving customer-feedback related data during a preconfigured period for the agent from a feedback-management component;
(ii) extracting parameters from the customer-feedback related data for each feedback, wherein the parameters include at least one of: feedback comment, associated Net promoter score (NPS), assigned categories, customer and agent details and associated interaction identifier;
(iii) retrieving mapping between categories and the first one or more groups;
(iv) operating an algorithm to calculate a CFRS for each category based on the extracted parameters based on the retrieved mapping;
(v) counting occurrences of each category to determine a median number for each category;
(vi) detecting a preconfigured number of categories having highest variance to yield impacted categories;
(vii) sorting interactions associated with the impacted categories based on NPS score; and
(viii) extracting a preconfigured number of associated interactions which have an NPS score below a preconfigured threshold and having lowest NPS score to be added to the generated coaching session.

3. The computerized-method of claim 2, wherein before calculating the CFRS normalizing the customer-feedback related data by NPS to yield customer-feedback related data having normalized NPS.

4. The computerized-method of claim 3, wherein the customer-feedback related data by NPS is normalized based on formula I:
$$\hat{X} [ : , i ] = \frac{X [ : , i ] - min ( X [ : , i ] )}{max ( X [ : , i ] ) - min ( X [ : , i ] )} \qquad ( I )$$
whereby
\hat{X}[:,i] is a normalized NPS score,
X[:,i] is NPS score of current feedback instance,
min(X[:,i]) is minimum NPS score within all the feedback instances for respective agent, and
max(X[:,i]) is maximum NPS score within all the feedback instances for an agent.

5. The computerized-method of claim 3, wherein the computerized-method further comprising identifying impacted categories in the customer-feedback related data having normalized NPS by counting feedback comments in each category.

6. The computerized-method of claim 1, wherein the first one or more groups and the second one or more groups include: focus area, behavior and knowledge base artifacts.

7. The computerized-method of claim 1, wherein the web application for managing coaching sessions is a cloud-based application which is implemented as a workflow and having distributed component units and wherein the web application is interacting with a service to coordinate work across the distributed component units.

8. The computerized-method of claim 1, wherein the retrieved mapping between categories and one or more groups is preconfigured by a user of the web application for managing coaching sessions.

9. The computerized-method of claim 2, wherein the operated algorithm is k-Nearest neighbors algorithm.

10. The computerized-method of claim 1, wherein the detecting of the preconfigured number of categories having highest variance is operated by an isolation forest algorithm.
The computerized-method of claim 1, wherein upon user selection of the determined second one or more groups presenting the maximum CFRS and a notification that maximum CFRS achieved
